(19) United States
(12) Patent Application Publication
(10) Pub. No.: US 2018/0109132 A1
(43) Pub. Date: Apr. 19, 2018

(54) ELECTRONIC DEVICE WITH WIRELESS CHARGING STRUCTURE

(71) Applicant: Samsung Electronics Co., Ltd., Gyeonggi-do (KR)

(72) Inventors: Bumjin CHO, Gyeonggi-do (KR); Okon KWON, Seoul (KR)

(21) Appl. No.: 15/783,733

(22) Filed: Oct. 13, 2017

(30) Foreign Application Priority Data
Oct. 19, 2016 (KR) 10-2016-0135495

(51) Int. Cl. H02J 7/02; H01F 38/14; H04B 5/00

(52) U.S. Cl. CPC H02J 7/025; H04B 5/0037; H04B 5/0031; H01F 38/14

(57) ABSTRACT

An electronic device including a wireless charging structure is provided. The electronic device may include a housing including a first plate facing a first direction, a second plate facing a second direction opposite the first direction, and a side member; a processor; a wireless communication circuit; and an electrically conductive coil that is wound around an axis extending in the second direction. The second plate may include a conductive substrate; an opening formed through or in a portion of the conductive substrate; a plurality of first conductive strips extending from a first position around the opening to a second location around the opening. The plurality of first conductive strips are electrically connected to the first portion and electrically disconnected from the second portion and extend from the opening; and an insulating material filled in at least a portion of the opening.

### PRIORITY

This application claims priority under 35 U.S.C. § 119(a) to Korean Patent Application Serial No. 10-2016-0135495, which was filed in the Korean Intellectual Property Office on Oct. 19, 2016, the entire content of which is incorporated herein by reference.

### BACKGROUND

### 1. Field of the Disclosure

The present disclosure relates to technology to wirelessly charge an electronic device.

### 2. Description of Related Art

Generally, an electronic device may be charged by placing the electronic device on a charger, or by connecting the electronic device to a power supply via a charging cable.

Further, the electronic device may be charged in a wireless manner by placing the electronic device on a charging cradle. For example, the electronic device may have a reception coil, and the charging cradle may include a transmission coil such that the electronic device is charged in a wireless manner by the induction current which is generated in the reception coil when current is applied to the transmission coil.

However, when the housing of the electronic device is made of a metal material, and in particular, when a rear cover of the housing is made of a metal material, this may prevent the electronic device from being charged in a wireless manner. For example, when the electronic device with a metal rear cover is wirelessly charged, reverse current may be generated by the metal rear cover, thereby hindering the generation of the induction current.

### SUMMARY

Accordingly, the present disclosure is designed to address at least the problems and/or disadvantages described above and to provide at least the advantages described below.

An aspect of the present disclosure is to provide an electronic device including a housing that is made of a metal material, which is capable of being efficiently charged in a wireless manner, by removing at least a portion of the metal material of the rear cover of the housing.

Another aspect of the present disclosure is to provide an electronic device including a housing that is made of a metal material, which is capable of being efficiently charged in a wireless manner, by including a slit region in at least a partial region of the rear cover of the housing.

In accordance with an aspect of the present disclosure, an electronic device is provided, which includes a housing including a first plate facing a first direction, a second plate facing a second direction opposite to the first direction, and a side member surrounding a space between the first and second plates; a touch screen display exposed through the first plate; a processor located in the space; a wireless communication circuit located in the space and electrically connected to the processor; and an electrically conductive coil located in the space and electrically connected to the wireless communication circuit. The electrically conductive coil is wound around an axis extending in the second direction. The second plate includes a conductive substrate; an opening formed in at least one of through and in a portion of the conductive substrate. A substantial portion of the coil is located between the opening and the first plate; a plurality of first conductive strips extending from a first position around the opening to a second location around the opening. The plurality of first conductive strips are electrically connected to the first portion and electrically disconnected from a second portion and extend from the opening; and an insulating material filled in at least a portion of the opening.

In accordance with another aspect of the present disclosure, an electronic device is provided, which includes a rear cover; and a housing disposed to overlap the rear cover and including therein a wireless charging coil body configured to generate induction current during wireless charging of the electronic device. The rear cover includes a conductive substrate; an opening formed in a portion of the conductive substrate; a plurality of conductive strips extending from the opening; a plurality of slits each disposed between each two adjacent conductive strips; and at least a portion of the opening filled with an insulating material.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1A is a perspective view illustrating the front face of an electronic device according to an embodiment of the present disclosure;

FIG. 1B is a perspective view illustrating the rear face of an electronic device according to an embodiment of the present disclosure;

FIG. 2 is an exploded perspective view illustrating the internal configuration of the electronic device according to an embodiment of the present disclosure;

FIG. 3 is an exploded perspective view illustrating an electronic device according to an embodiment of the present disclosure;

FIG. 4 is a block diagram illustrating the configuration of a wireless charging structure according to an embodiment of the present disclosure;

FIG. 5A is a view illustrating a state in which a rear cover made of a metal material is interposed between a transmission coil and a reception coil when an electronic device according to an embodiment of the present disclosure is placed on a charging cradle;

FIG. 5B is a view illustrating a reverse current phenomenon generated by a rear cover made of a metal material when the electronic device illustrated in FIG. 5A is wirelessly charged;

FIG. 6 is an exploded perspective view illustrating the internal configuration of an electronic device that is provided with a wireless charging structure according to an embodiment of the present disclosure;

FIGS. 7A to 7D are views each illustrating a metal removed region formed in a rear cover according to an embodiment of the present disclosure;

FIGS. 8A and 8B are views each illustrating a slit region formed in a rear cover according to an embodiment of the present disclosure;

FIGS. 9A and 9B are views each illustrating a slit region formed in a rear cover according to an embodiment of the present disclosure;

FIGS. 10A to 10D are views each illustrating a slit region formed in a rear cover according to an embodiment of the present disclosure;

FIG. 11 is a view illustrating a slit region formed in a rear cover according to an embodiment of the present disclosure;

FIG. 12 is an exemplary view illustrating a slit region formed in a rear cover according to an embodiment of the present disclosure; and

FIGS. 13A to 13F are views sequentially illustrating a method of manufacturing a rear cover according to an embodiment of the present disclosure.

### DETAILED DESCRIPTION

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications, equivalents, and/or alternatives within the spirit and scope of the present disclosure. In the description of the drawings, similar reference numerals may be used to designate similar elements.

The terms used to describe one or more embodiments are not intended to limit the present disclosure. As used herein, singular forms may include plural forms as well unless the context explicitly indicates otherwise. Further, all of the terms used herein, including technical and scientific terms, have the same meanings as commonly understood by those of skill in the art to which the present disclosure pertains. Terms, such as those defined in a generally used dictionary, are to be interpreted to have the same meanings as the contextual meanings in the relevant field of art, and are not to be interpreted to have ideal or excessively formal meanings unless clearly defined as such herein.

Herein, the expressions “include”, “may include” and other conjugates refer to the existence of a corresponding disclosed feature, numeral, step, function, operation, element, component, or a combination thereof, and do not limit one or more additional features, numerals, steps, functions, operations, elements, components, or a combination thereof.

The expression “or” or “at least one of A or/and B” includes any or all of combinations of words listed together. For example, the expression “A or B” or “at least A or/and B” may include A, may include B, or may include both A and B.

Expressions including ordinal numbers, such as “first,” “second,” etc., may modify various elements. However, such elements are not limited by the above expressions. For example, the above expressions do not limit the sequence and/or importance of the elements. The above expressions may be used merely for the purpose of distinguishing an element from the other elements. For example, a first user device and a second user device indicate different user devices although both of them are user devices. For another example, a first element may be referred to as a second element, and likewise a second element may also be referred to as a first element without departing from the scope of embodiments of the present disclosure.

When an element is referred to as being “coupled” or “connected” to any other element, the element may be directly coupled or directly connected to the other element, or a third element may be interposed there between. However, when an element is referred to as being “directly coupled” or “directly connected” to any other element, no other element is interposed there between.

An electronic device according to the present disclosure may be a device including a communication function, such as a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g. a head-mounted-device, such as electronic glasses, electronic clothing, an electronic bracelet, an electronic necklace, an electronic accessory, an electronic tattoo, or a smartwatch).

The electronic device may also be a smart home appliance with a communication function, such as a television, a digital versatile disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic photo frame.

The electronic device may include a medical appliance (e.g., a magnetic resonance angiography (MRA) device, a magnetic resonance imaging (MRI) device, a computed tomography (CT) device, and an ultrasonic machine), navigation equipment, a global positioning system (GPS) receiver, an event data recorder (EDR), a flight data recorder (FDR), an automotive infotainment device, electronic equipment for a ship (e.g., ship navigation equipment and a gyrocompass), avionics, security equipment, a vehicle head unit, an industrial or home robot, an automatic teller machine (ATM), and a point of sales (POS) device.

The electronic device may also include at least one of a part of furniture or a building/structure, an electronic board, an electronic signature receiving device, a projector, and measuring instruments (e.g., a water meter, an electric meter, a gas meter, and a radio wave meter).

Further, the electronic device may be a flexible device.

The electronic device may be a combination of the aforementioned devices.

Further, the electronic device is not limited to the aforementioned devices.

The term “user” as used herein may indicate a person who uses an electronic device or a device (e.g., an artificial intelligence electronic device) that uses an electronic device.

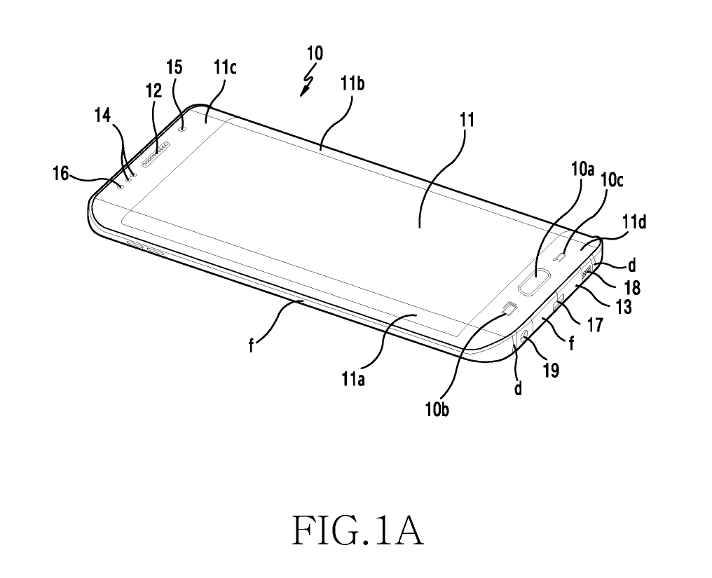

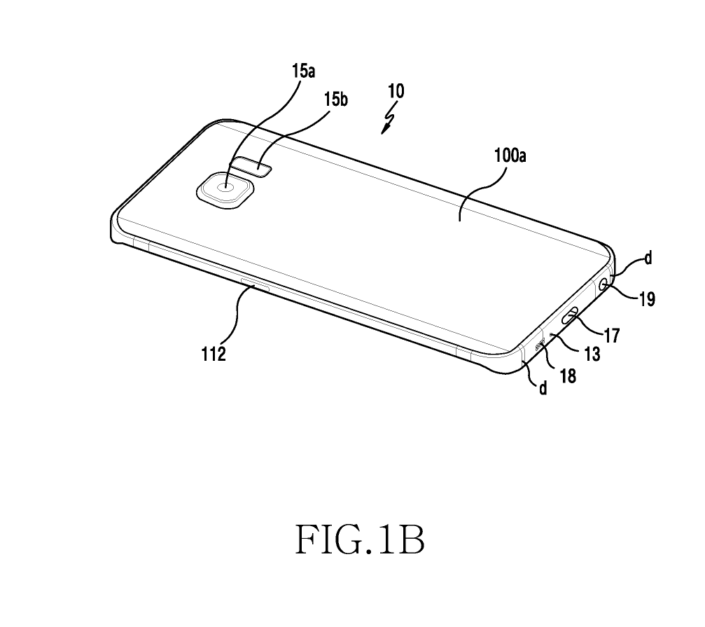

FIG. 1A is a perspective view illustrating the front face of an electronic device according to an embodiment of the present disclosure, and FIG. 1B is a perspective view illustrating the rear face of an electronic device according to an embodiment of the present disclosure.

Referring to FIGS. 1A and 1B, an electronic device 10 includes a display 11, which may be a touch screen, on the front face thereof. A receiver 12 is disposed above the display 11 to receive the voice of a counterpart, e.g., another electronic device. A microphone 13 is disposed below the display 11 to transmit a voice of the user of the electronic device to a counterpart electronic device.

Components for performing functions of the electronic device 10 may be arranged around the receiver 12 in the electronic device 10. The components include one or more sensor modules 14. The sensor modules 14 may include at least one of an illuminance sensor (e.g., an optical sensor), a proximity sensor (e.g., an optical sensor), an infrared sensor, and an ultrasonic sensor. The components include a front camera 15. The components include an indicator 16 configured to inform the user of the status information of the electronic device 10.

The display 11 may be formed as a large screen to occupy a greater portion of the front face of the electronic device 10. For example, the display of the electronic device may be configured as a flat display, a curved display having a curvature, or a combined display having both a flat surface and a curved surface.

The covered display may be disposed at an edge of the flat display. Curved displays may be disposed on both side edges 11a and 11b of the flat display, respectively. In addition, each of the upper and lower regions 11c and 11d of the flat display needs not be limited to a flat display, and may be configured as a curved display.

The main home screen refers to the first screen that is displayed on the display 11 when the electronic device 10 is turned on or awoken from a sleep state. In addition, when the electronic device 10 has several pages of different home screens, the main home screen may be the first home screen among the several pages of home screens. The home screen may display shortcut icons to execute frequently used applications, a main menu switching key, time, weather, etc. The main menu switching key may cause the main screen to be displayed on the display 101. In addition, in the upper end of the display 11, status bars may be formed to indicate the statuses of the electronic device 10, such as a battery charge status, a received signal strength, and the current time. Below the display 11, a home key 10a, a menu key 10b, a back key 10c, and the like may be formed.

The home key 10a may cause the main home screen to be displayed on the display 11. For example, when the home key 10a is touched in the state of a home screen is other than the main home screen, or the menu screen is displayed on the display 11, the main home screen may be displayed on the display 11. In addition, when the home key 10a is touched while applications are executed on the display 11, the main home screen may be displayed on the touch screen 11. In addition, the home key 10a may also be used in order to cause the most recently used application or a task manager to be displayed on the display 11. The home key 10a may be deleted from the front portion of the electronic device 100. A fingerprint recognition sensor device may be disposed on the top surface of the home key 10a. For example, the home key may be configured to perform a first function (e.g., the home screen return function or a wake-up/sleep function) by an operation of physically pressing the home key button, and to perform a second function (e.g., a fingerprint recognition function) by an operation of swiping the top surface of the home key.

The menu key 10b may provide a connection menu that may be used on the display 11. For example, the connection menu may include a widget addition menu, a background screen change menu, a retrieve menu, an edition menu, and an environment setting menu. The back key 10c may cause the screen, which was executed immediately prior to the currently executed screen, to be displayed, or may cause the most recently used application to be terminated.

The electronic device 10 may include a metal frame f as a metal housing. The metal frame f may be arranged along the rim of the electronic device 10, and may be disposed to expand to at least a partial region of the rear face of the electronic device 10 that extends from the rim. The metal frame f forms at least a portion of the thickness of the electronic device 10 along the rim of the electronic device 10, and may be formed in a segmented structure.

The metal frame f may be disposed in only a partial region of the rim of the electronic device 10. When the metal frame f is a portion of the housing of the electronic device 10, the remaining portion of the housing may be replaced by a non-metallic member. The housing may be formed in a manner in which the non-metallic member is molded on the metal frame f through insert injection molding. The metal frame f includes one or more split portions d such that a unit metal frame separated by the segmenting portions d may be utilized as an antenna radiator. An upper frame may be a unit frame defined by a pair of split portions d formed at a predetermined interval. A lower frame may serve as a unit frame defined by a pair of split portions d formed at a predetermined interval. The split portions d may be formed in unison when the non-metallic member is molded on a metal member through insert injection molding.

Various electronic components may be disposed on the metal frame f. A speaker 18 is disposed at one side of the microphone 13. At the other side of the microphone 13, an interface connector 17 is disposed such that a data transmission/reception function with an external device and external power may be applied thereto in order to charge the electronic device 10. An ear jack hole 19 is disposed at one side of the interface connector 17. The microphone 13, speaker 18, interface connector 17, and ear jack hole 19 may be disposed within the region of the unit frame that is formed by a pair of split portions d disposed in the metal frame f. Without being limited thereto, however, at least one of the above-mentioned electronic components may be disposed within a region that includes the split portions d, or outside the metal frame f.

At least one side key button may be disposed on the metal frame f. A pair of side key buttons may be disposed to protrude on the left frame f to perform a volume up/down function, a scroll function, or the like. One or more second side key buttons may be disposed on the right frame f. The second side key buttons 112 may perform a power ON/OFF function, a wake-up/sleep function of the electronic device, or the like.

A rear camera 15a is disposed on the rear face 100a of the electronic device 10, and one or more electronic components 15b is disposed at one side of the rear camera 15a. For example, the electronic components may include at least one of an illuminance sensor (e.g., an optical sensor), a proximity sensor (e.g., an optical sensor), an infrared sensor, an ultrasonic sensor, a heart rate sensor, and a flash device.

The display 11 includes a left curved portion 11a and a right curved portion 11b, which are formed on the left and right sides, respectively. The front face of the electronic device 10 may include a display region and other regions in a single window. The left and right curved portions 11a and 11b may be formed to extend from the flat portion in the longitudinal axis direction of the electronic device 10. The left and right curved portions 11a and 11b may be lateral side faces of the electronic device 10. In this case, the left and right curved portions 11a and 11b, and the left and right metal frames f may form the side faces of the electronic device 10 together. Without being limited thereto, the front face including the display 11 may include only one of the left and right curved portions 11a and 11b.

The electronic device 10 may selectively display information by controlling a display module. The electronic device 10 may configure a screen only in the flat portion by controlling the display module. The electronic device 10 may control the display module to configure a screen in any one of the left and right curved portions 11a and 11b together with the flat portion. The electronic device 10 may control the display module to configure a screen in only one of the left and right curved portions 11a and 11b, except for the flat portion.

The entire rear face of the electronic device 10 may be formed by one rear external surface mounting member. The rear surface may include a flat portion that is formed substantially in the central portion, and may or may not include a left curved portion and a right curved portion to the left and right sides of the flat portion.

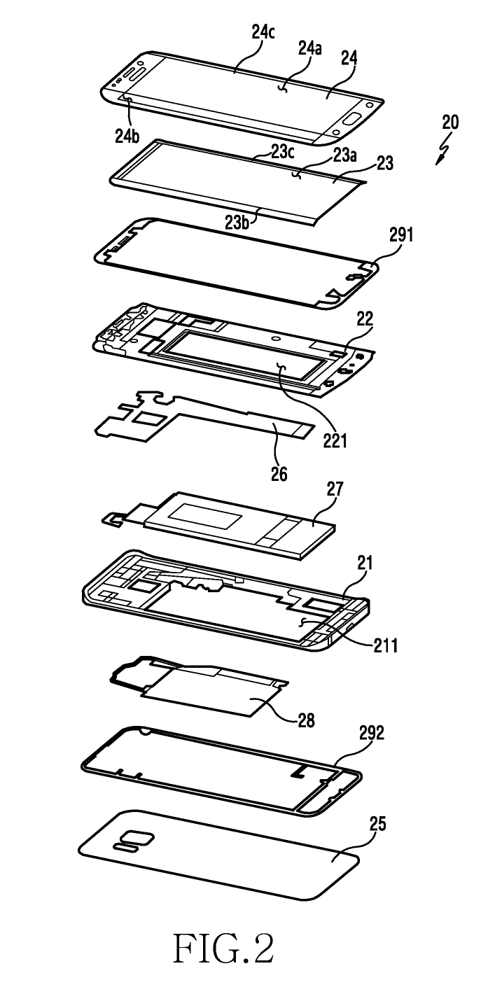

FIG. 2 is an exploded perspective view illustrating the internal configuration of an electronic device 20 according to an embodiment of the present disclosure. The electronic device 20 may be the same electronic device as the electronic device 10 described above, or at least a portion of the electronic device 20 may be the same as that of the electronic device 10.

Referring to FIG. 2, the electronic device 20 includes a PCB 26, an internal support structure 22, a display module 23, and a front window 24, which may be referred to as a first plate substantially facing a first direction, which are disposed in the manner of being sequentially stacked on the upper side of the housing 21.

The electronic device 20 includes a wireless power transmission/reception member 28 which may include a flexible printed circuit board provided with an antenna pattern, and a rear window 25, which may be referred to as a second plate substantially facing a second direction that is opposite the first direction, and may be disposed in the manner of being sequentially stacked on the lower side of the housing 21.

A battery pack 27 is accommodated in a battery pack accommodation space formed in the housing 21, and thus avoiding the printed circuit board 26. The battery pack 27 and the PCB 26 may be disposed parallel to each other without overlapping each other.

The display module 23 may be secured to the inner support structure 22, and the front window 24 may be attached to the inner support structure 22 by a first adhesive member 291. The rear window 25 may be secured in the manner of being attached to the housing 21 by the second adhesive member 292. The electronic device may include a side member that surrounds at least a portion of a space between the first plate and the second plate.

The front window 24 includes a flat portion 24a, and left and right bent portions 24b and 24c bent in the opposite directions from the flat portion 24a. For example, the front window 24 may be positioned on the electronic device 20 to form the front face, and may display a screen displayed on the display module 23 using a transparent material. Further, the front window 24 may provide an input/output window for sensors. The left and right bent portions 24b and 24c are illustrated as being formed in a 3D manner. However, the single-bent shapes may also be applied to the upper and lower portions in addition to the left and right bent portions, or dual-bent shapes may also be applied to the upper, lower, left, and right portions. A touch panel may be further disposed on the rear face of the front window 24, and may receive a touch input signal from the outside.

The display module 23 is formed in a shape corresponding to that of the front window 24 (e.g., a shape having a corresponding curvature). The display module 23 may include left and right bent portions about the flat face portion. The display module 23 may be a flexible display module. When the rear face of the front window 24 is in the form of a flat window type (hereinafter, referred to as a “2D form” or “2.5D form”), the rear face of the front window 24 is flat, and as a result, an ordinary liquid crystal display (LCD) or an on-cell TSP AMOLED (OCTA) may be applied.

The first adhesive member 291 is a component for securing the front window 24 to the internal support structure (e.g., a bracket) 22 disposed inside the electronic device. The first adhesive member 291 may be a kind of tape, such as a double-sided tape, or a liquid adhesive layer, such as a glue. For example, when a double-sided tape is applied as the first adhesive member 291, as an inner substrate, a general PET (polyethylene terephthalate) material may be applied or a functional substrate may be applied. For example, it is possible to strengthen impact resistance by using a piece of foam tape or a base material using an impact-absorbing fabric in order to prevent the front window from being damaged by external impact.

The inner support structure 22 may be disposed within the electronic device 20, and may be used as a component for strengthening the overall rigidity of the electronic device. For example, at least one of Al, Mg, and STS may be used for the inner support structure 22. For the inner support structure 22, a high-rigidity plastic containing glass fiber may be used, or a metal and a plastic may be used together. When a metal material and a non-metal material are used together as the material of the inner support structure 22, the inner support structure 22 may be formed in the manner of molding the non-metal material on the metal material through insert injection molding. The inner support structure 22 is positioned on the rear face of the display module 230. The inner support structure 22 may have a shape (e.g., curvature) similar to that of the rear face of the display module 23, and may support the display module 33. Between the inner support structure 22 and the display module 23, a sheet (e.g., a sponge, an elastic member such as a rubber, an adhesive layer such as a double-sided tape, or a single-sided tape) may be additionally disposed to protect the display module 23.

The electronic device 20 may further include an auxiliary device for reinforcing the internal rigidity or improving a thermal characteristic, an antenna characteristic, or the like by adding a metal or composite material in the form of a sheet material to a hole area as needed.

The inner support structure 22 may be fastened to the housing (e.g., the rear case) 21 in order to form a space therein, and one or more electronic components may be disposed in this space. The electronic components may include the PCB 26. Without being limited thereto, however, an antenna device, a sound device, a power supply device, a sensor device, and so on may be included in addition to the PCB 26.

The battery pack 27 may supply power to the electronic device 20. One face of the battery pack 27 may be adjacent to the display module 23, and the other face may be adjacent to the rear window 25. Thus, when the battery pack 27 swells during charging, the neighboring components may not be deformed or damaged. In order to prevent this, it is possible to protect the neighboring components by providing a space (e.g., swelling gap) between the battery pack 27 and the neighboring components. The battery pack 27 may be integrally disposed in the electronic device 20. However, the present disclosure is not limited thereto, and when the rear window 25 is implemented to be detachable from the electronic device 20, the battery pack 27 may also be implemented to be detachable.

The housing 21 may form the exterior (e.g., the side face including a metallic bezel) of the electronic device 20, and may be coupled with the internal support structure 22 to form an interior space. The front window 24 may be disposed on the front face of the housing 21, and the rear window 25 may be disposed on the rear face of the housing 21. However, without being limited thereto, the rear face may be implemented using an injection-molded synthetic resin, a metal, a composite of a metal and a synthetic resin, and the like. The gap between the housing 21 and the internal structure formed by the rear window 25 may prevent the rear window 25 from being damaged by secondary impact caused by the internal structure when an external impact occurs, such as when the electronic device is dropped.

The wireless power transmission/reception member 28 may be disposed on the rear side of the housing 21. The wireless power transmission/reception member 28 may be attached to one face of an internal mounting component or to a partial region of the inner face of the housing 21, particularly a region generally adjacent to the rear window 25, in the form of a thin film, and may include a structure that forms a contact with the PCB 26 therein. The wireless power transmission/reception member 28 may be embedded or attached as a portion of a housing 21 or a component, such as the battery pack 27, and may be provided in the form of being simultaneously attached to both of the component and the housing 210.

The second adhesive member 292 is a component for fixing the rear window 25 to the housing 21, and may be applied in a form similar to the above described first adhesive member 291.

The rear window 25 may be applied in a form similar to the front window 24 described above. The front face (e.g., the face exposed to the outside) of the rear window 25 may be formed in a curvature in which an inclined angle increases toward the left and right ends. The rear face of the rear window 25 is formed in a flat face, and may be bonded to the housing 21 by the second adhesive member 292.

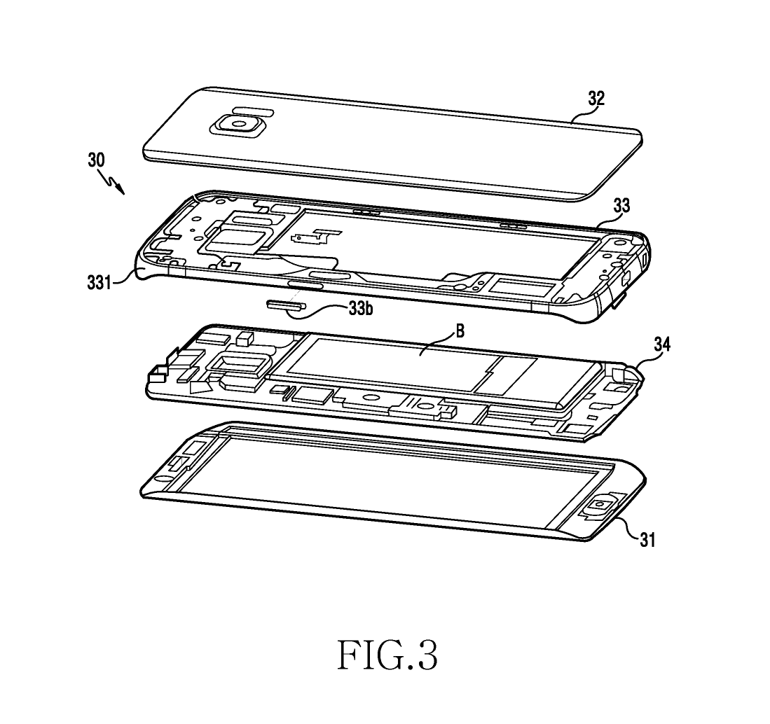

FIG. 3 is an exploded perspective view illustrating the main configuration of the electronic device according to an embodiment of the present disclosure.

Referring to FIG. 3, an electronic device 30 may have at least one member related to the appearance thereof on the external face thereof. For example, over a great part of the external appearance of the electronic device 30, exterior members, such as a front cover 31, a rear cover 32, and a case 33 including side walls 331 may be disposed. In addition, in the external appearance of the electronic device 30, a home key, a receiver, etc., may be disposed on the front face of the electronic device 30; a rear camera, a flash, or a speaker may be disposed on the rear face of the electronic device 30; and a plurality of physical keys, a connector or a microphone hole may be disposed in the side walls 331.

In the electronic device 30, the members may be disposed on the exterior of the electronic device to prevent foreign matter, such as water, from penetrating into the inside of the electronic device. The electronic device 30 may include a front cover 31, a back cover 32, a case 33, a structure 34, and a waterproofing structure.

The front cover 31 may form the front face of the electronic device 30, and may form the exterior appearance of the front face of the electronic device 30. The front cover of the electronic device 30 may be made of a transparent member. For example, the transparent member may include transparent synthetic resin or glass. The display supported on the structure may include a screen region exposed through the front cover.

The rear cover 32 may form the rear face of the electronic device 30, and may form the external appearance of the rear face of the electronic device 30. The rear cover 32 of the electronic device 30 may be configured as a transparent or opaque member. For example, the transparent member may include a transparent synthetic resin or glass, and the opaque member may be made of a material, such as a translucent, opaque synthetic resin, or a metal.

The side wall 331 of the case 33 may form the rim side face of the electronic device 30, and may form the external appearance of the side face. The side wall 331 of the electronic device may be made of a conductive material, e.g., may be configured as a conductive side wall. For example, the side wall may be made of a metal material, such that the side wall may operate as an antenna radiator. The side wall 331 may surround at least a portion of the space provided by the front cover 31 and the rear cover 32. The side wall 331 may be formed integrally with a conductive structure or a non-conductive structure.

Alternatively, a plurality of internal support structures 34 may be provided, in which a first structure may be configured to support the display, a substrate, etc., and a second structure may be configured to support an exterior member. For example, a structure may be configured to be capable of supporting and protecting other components, such as the battery B. The inner support structure 34 may be made of a synthetic resin, a metal, or a combination thereof, and may also be made of a metal alloy containing magnesium.

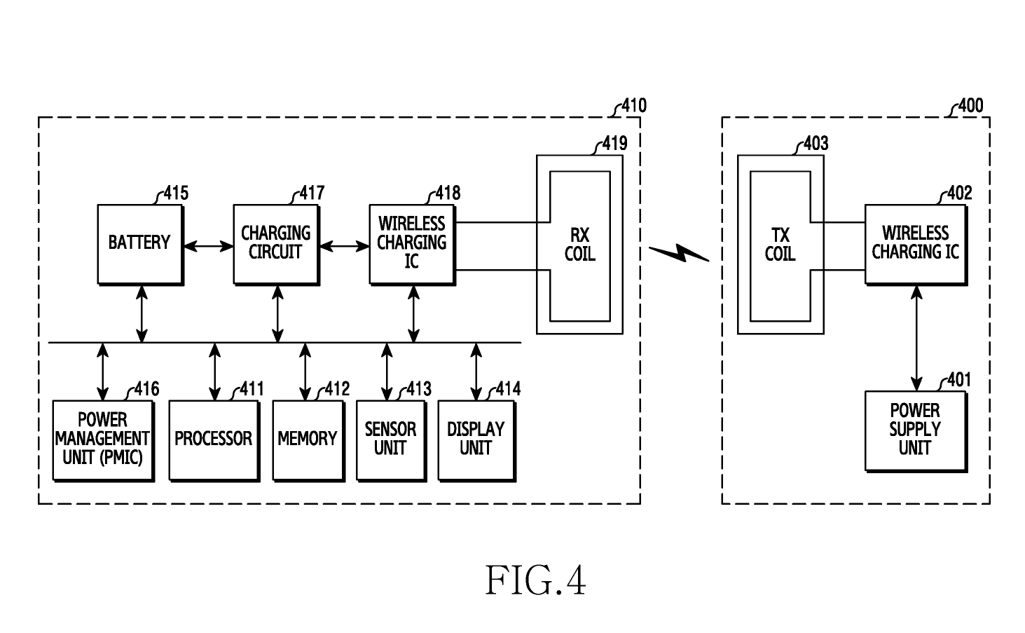

Referring to FIG. 4, a wireless power transmission device 400 may wirelessly transmit power through a TX coil 403 which is connected to a wireless charging IC 402 via an external or internal power supply unit 401. The power of the wireless power transmission device 400 may supply power in the form of an AC waveform, or may convert power of a DC waveform into an AC waveform and may wirelessly supply the converted power. The wireless charging IC 402 may be disposed in a space within the housing, and may be connected to a printed circuit board.

The wireless power reception device 410 may include an electronic device that may wirelessly receive power. The electronic device may include a processor 411, a memory 412, a sensor unit 413, a display unit 414, a battery 415, a power management unit 416, a charging circuit 417, a wireless charging IC 418, and an RX coil 419.

The wireless power reception device 410 is provided with an RX coil 419 configured to receive wireless power that is transmitted in the form of a changing magnetic field or electromagnetic field. The wireless power reception device 410 includes the wireless charging IC 418 that includes a function of processing the wireless power transmitted from the RX coil 419, and a function of communicating with the wireless power transmission device 400. The wireless charging IC 418 may further include a rectifying circuit configured to convert the received wireless power into direct current, a smoothing circuit, and a circuit configured to prevent overvoltage and overcurrent. The power received through the wireless charging IC 418 may charge the battery 415 or may supply the operating power to the electronic device, via the power management unit 416 or the wireless charging IC 418. The wireless charging IC 418 may be provided with a communication unit that allows the wireless charging IC 418 to perform communication with respect to information on power transmission, a charging function control signal, and so on, based on a preset method. The information on the power transmission may include information, such as a capacity, a remaining battery charge, the number of times of charging, usage, a battery capacity, and a battery ratio. The charging function control signal may be a control signal that enables or disables the charging function. The wireless communication unit may be configured to transmit and/or receive signals in a frequency range below 15 MHz. For example, the wireless communication unit may include a near-field communication (NFC protocol).

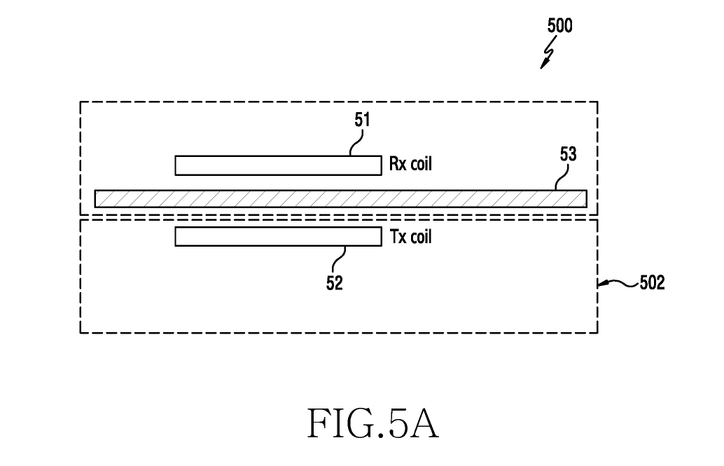

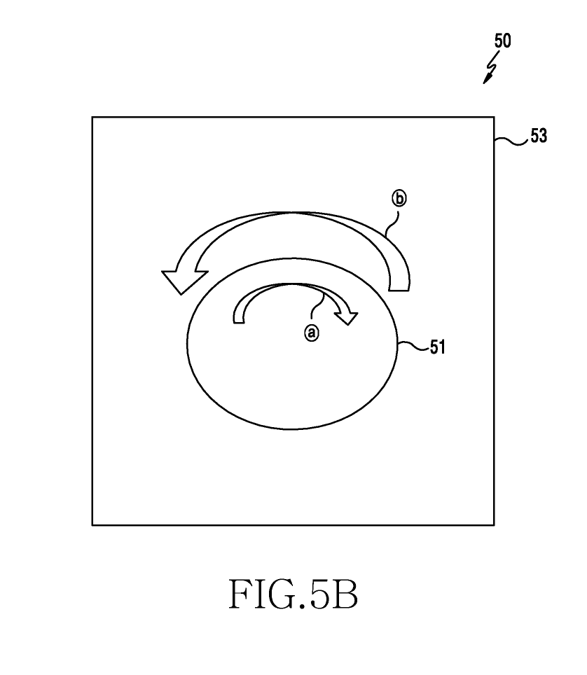

Referring to FIGS. 5A and 5B, a wireless power reception device 500 including an electronic device is provided with a reception coil body 51 for placement in a wireless charging manner, and a wireless charging transmission device 502 includes a transmission coil body 52. For example, when the rear cover 53 of the housing of the wireless charging reception device 500 placed on the wireless charging transmission device 502 is made of a metal material, a rear cover 53 made of a metal material may be disposed between the reception coil body 51 and the transmission coil body 52.

The wireless charging structure may be configured such that, when current is applied to the transmission coil body 52, magnetic force lines are generated in the transmission coil body 52, and an H field is induced in the reception coil body 51 and converted into current. When the cover 53 made of the metal material is placed between the transmission coil body 52 and the reception coil body 51, the current induced in the transmission coil body 52 is induced in the form of a mirror effect, and the H field energy is not activated, so no energy transfer occurs.

That is, due to the occurrence of reverse eddy current flowing in the reverse direction, indicated by arrow \textcircled{b}, of the induction current flowing in the direction of arrow \textcircled{a} due to the rear cover 53 made of the metal material and positioned on the rear face of the electronic device, generated induction currents may be canceled with each other and the magnetic force generation may be reduced below a reference value. Therefore, an electronic device with a rear face made of a metal material, may not be charged by a wireless charging method. The rear cover 53 of the electronic device for wireless charging should include a structure capable of minimizing reverse current or eddy current, should solve the problem of a foreign object detection (FOD) issue, and should have a structure that can maintain compatibility with the transmission coil body 52.

The above-mentioned FOD refers to a protocol that prevents wireless charging from being performed when a foreign substance (e.g., key, card, etc.) other than the reception coil body 51 exists on the transmission coil body 52, and forcibly stops the wireless charging when a foreign metal substance exists between the transmission coil body and the reception coil body during the wireless charging, i.e., a standard that is defined in order to prevent a heat generation problem or the like from occurring when the charging efficiency is reduced due to the presence of a foreign metal substance.

The compatibility with the transmission coil body is confirmed to be compatible with the transmission coil body products already on market using a Qi certification process. In the procedure, about 200 transmission products are confirmed to charge an electronic device for about 5 minutes for each transmission coil body product. Only one electronic device failure to charge during the overall certification process will cause the Qi certification to be denied.

The charging structure illustrated in FIGS. 5A and 5B may be a structure that is not applicable due to the FOD issue or compatibility certification.

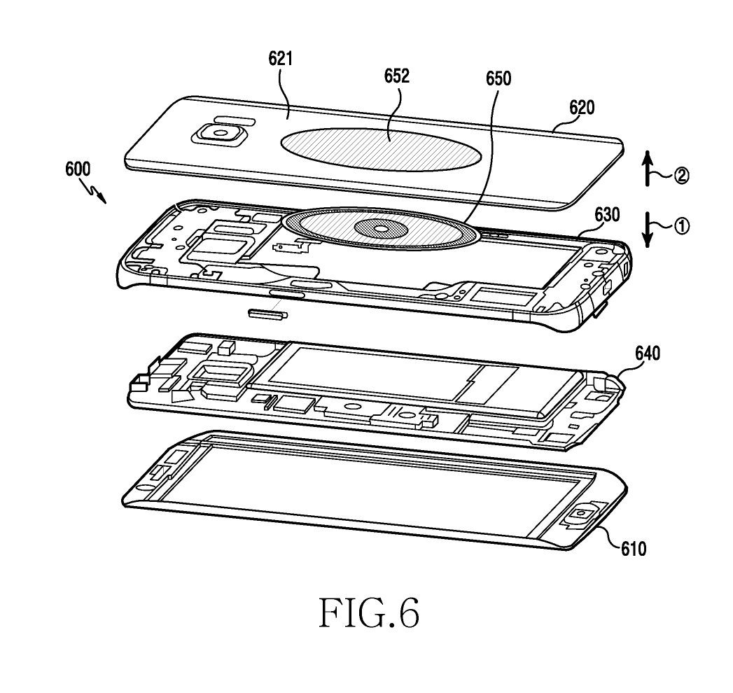

Referring to FIG. 6, the electronic device 600 includes a housing 630 that constitutes an external appearance and on which various electronic components are mounted.

The housing 630 includes a first plate 610 facing a first direction, a second plate 620 facing a second direction opposite the first direction, and side members that respectively face directions perpendicular to the first and second directions and that at least partially surround a space between the first and second plates 610 and 620. Since the housing 630 accommodates and protects components, the housing 630 may perform a cover function. For example, the first plate 610 of the housing may include a window of a transparent material described below, the second plate 620 of the housing may include one of a rear housing, a rear case, and a rear cover, and the side members of the housing 630 may include a side frame of the housing.

The second plate 620 may be manufactured integrally with the housing 630, or may be configured to be detachable from the housing 630. When the second plate 620 is configured to be detachable from the housing 630, the second plate 620 may include one of a battery cover, an accessory cover, and a detachable cover.

In the housing 630, a touch screen display may be disposed on the first plate 610 to be exposed to the user, and the rear cover may be positioned on the second plate 620. The second plate 620 may be configured with at least a portion of the housing 630, and may be made of the same material as at least a portion of the housing 630. In addition, a portion of the second plate 620 may be made of a metal material, and the remaining portion may be made of a non-metallic material. The second plate 620 may be integrally manufactured with the housing 630, or may be separately manufactured and coupled to the housing 630.

At least a portion of the housing 630 may be made of a metal material, and the remaining portion of the housing 630 may be made of a non-metallic material. For example, the housing 630 may be entirely made of a metal material, a non-metallic material, or a combination of a metal material and a non-metallic material.

At least a portion of the housing 630 may be made of a magnetic material, and the remaining portion of the housing 630 may be made of a non-magnetic material. For example, the housing 630 may be entirely made of a magnetic material, a non-magnetic material, or a combination of a magnetic material and a non-magnetic material.

The second plate 620 includes a conductive substrate 621 and an opening 652 facing the coil 650. The opening 652 is a region where, a portion of the conductive substrate 621 (e.g., the portion facing the conductive coil 650) is at least partially removed, and may be provided as a single opening shape region or a slit region in which a plurality of slits are formed. Otherwise, the opening 652 may be defined as a non-metal region. The opening 652 may be filled with a non-metallic material, for example, an insulating material. As will be described later, the opening 652 may be referred to as a slit region when a plurality of slits are formed therein.

The opening 652 may be formed through or in a portion of the conductive substrate 621. A substantial portion of the coil 650 may be positioned between the opening 652 and the first plate 610.

The electronic device 600 includes a support structure 640 and the coil 650. The support structure 640 is a support member for supporting a touch screen display, a printed circuit board, and the like, and may be made of a metal material, a metal alloy, or a synthetic resin.

The conductive coil 650 may be a coil body or coil bundle in which a coil is wound a plurality of times on a flexible circuit board, and may be a portion in which induction current is generated when the electronic coil 600 is placed on a wireless charging cradle in order to perform wireless charging. The conductive coil 650 may be a thin plate which may be formed in a circular or elliptical shape when viewed from above, or may be formed in a square or rectangle shape having rounded corners. The conductive coil 650 may be electrically connected to a wireless communication circuit disposed on a printed circuit board, and may be configured to be wound multiple times around an axis extending in the second direction of the housing 630. For example, the conductive coil 650 which is wound a plurality of times may be configured in the shape of a slim plate having a predetermined thickness.

According to an embodiment of the present disclosure, in the electronic device 600, at least a portion of the second plate 620 may be removed in order to minimize metal interference and to receive wireless power through the coil 650. For example, the metal of the second plate 620 in the region where the coil 650 is positioned may be finely divided into slit shapes, or may be formed in an opening shape. In addition, since the eddy current may become stronger as the metal thickness becomes thicker, the second plate 620 may be configured to have a metal thickness that is equal to or less than a set thickness.

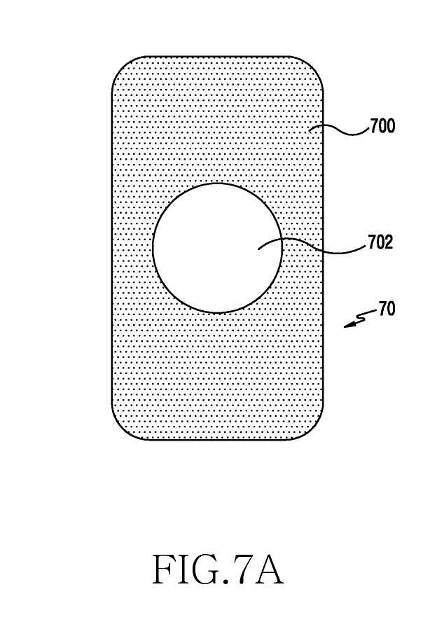

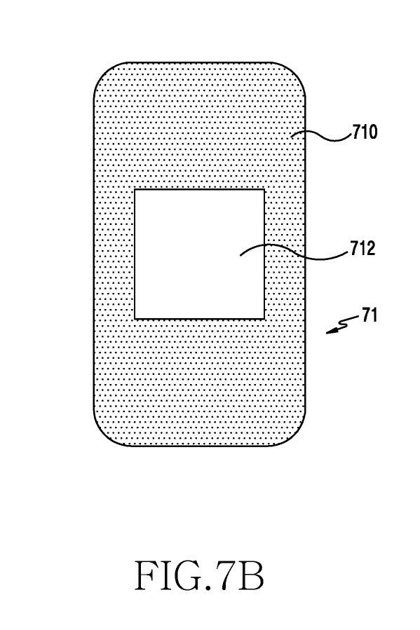

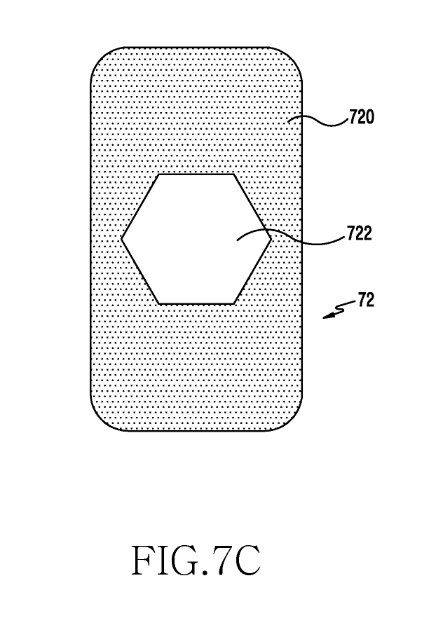

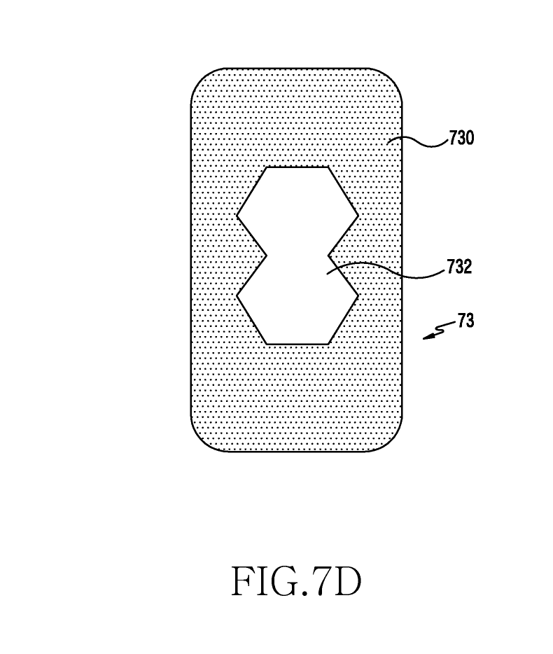

FIGS. 7A to 7D illustrate second plates having openings of various shapes.

Referring to FIG. 7A, a second plate 70 includes an opening 702 disposed in the approximately central region of the circular conductive substrate 700 when viewed from above is a region where a metal portion is removed. Further, the opening 702 may be filled with any one of a non-metallic material, an insulating material, and a non-magnetic material.

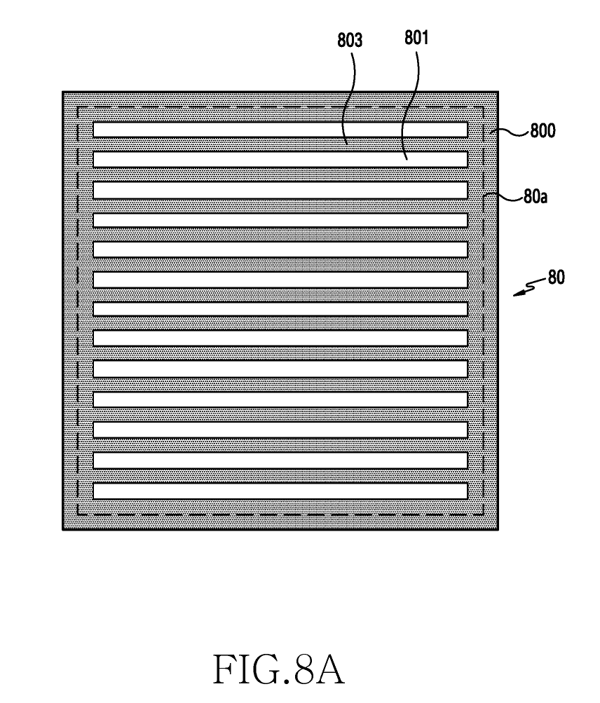

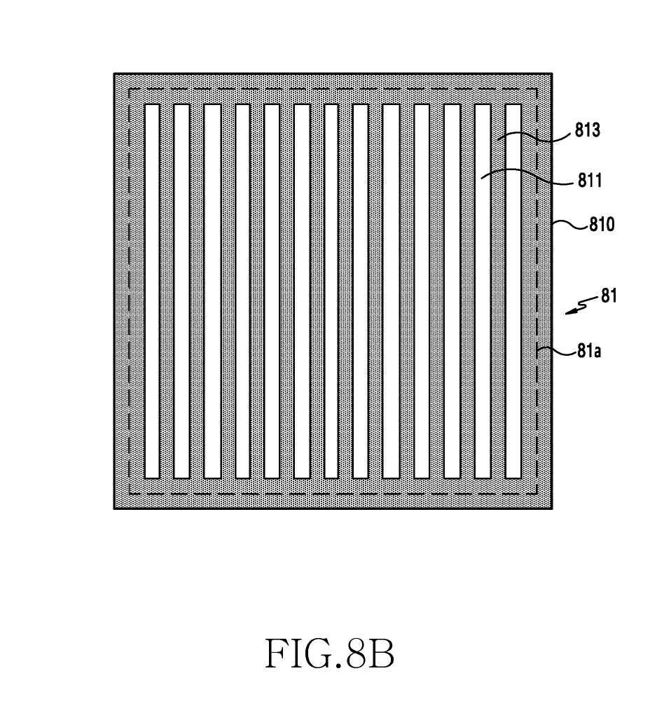

According to various embodiments of the present disclosure, each of the slit regions illustrated in FIGS. 8 to 12 may be applied to the opening 702.

The conductive coil may have a thin plate shape, and may be formed in a circular shape when viewed from above. The minimum outer diameter size of the opening 702 may be equal to the diameter size of the conductive coil. For example, the diameter size of the coil may be 40 mm or more, and the minimum outer diameter size of the opening 702, which is approximately opposite the coil, may also be approximately 40 mm or more. When the minimum outer diameter size of the opening 702 is set to the same diameter as the coil, the best performance may be exhibited in the wireless charging compatibility test and the efficiency test.

Referring to FIG. 7B, the second plate 71 includes a square or rectangular opening 712 disposed in the approximately central region of the conductive substrate 710 when the second plate 71 is viewed from above. The opening 712 may be formed as a single square or rectangular opening. For example, the opening 712 may include a first side and a second side parallel to the first side. The first side may form at least a portion of the first portion of the conductive substrate 710 and the second side may form at least a portion of the second portion of the conductive substrate 710. The first side may be one end of the opening 712, and the second side may be the other end of the opening that is opposite the one end. Further, one end may be the first portion and the other end may be the second portion.

The opening 712 may be filled with a non-metallic material, a non-magnetic material, or an insulating material. A coil may have a thin plate shape and may be formed in a rectangular or substantially rectangular shape when viewed from above. The square or rectangular opening 712 may be replaced with a square or rectangular metal removal region. Further, a coil facing the opening 712 may be configured to have a size that is sufficiently large to cover the entire wireless charging coil body facing the coil.

According to various embodiments of the present disclosure, each of the slit regions illustrated in FIGS. 8 to 12 may be applied to the opening 712.

Referring to FIG. 7C, the second plate 72 includes a polygonal (e.g., hexagonal) opening 722 disposed in the approximately central region of the conductive substrate 720 when the second plate 72 is viewed from above. Further, the opening 722 may be filled with any one of a non-metallic material, a non-magnetic material, and an insulating material.

Further, the coil facing the opening 722 is not limited to the hexagonal shape, and may be formed in various shapes. The opening 722 may be configured to have a size that is sufficiently large to cover the entire coil facing the opening 722. For example, the opening 722 may also be configured to correspond to the various shapes of the coils.

According to various embodiments of the present disclosure, each of the slit regions illustrated in FIGS. 8 to 12 may be applied to the opening 722.

Referring to FIG. 7D, the second plate 73 includes a metal removal region 732 disposed in the approximately central region of the metal region when the second plate 73 is viewed from above. The metal removal region 732 is formed in a shape obtained by joining two metal removal regions 722. For example, two hexagonal metal removal regions may be formed such that at least two wireless charging coil bodies may be provided.

Further, the opening 732 may be filled with a non-metallic material, a non-magnetic material, or an insulating material.

Further, a coil facing the opening 732 may be formed in a circular shape, an elliptical shape, a polygonal shape, or the like. The opening 732 may be configured to have a size that is sufficiently large to cover the entire coil facing the opening 722.

According to various embodiments of the present disclosure, each of the slit regions illustrated in FIGS. 8 to 12 may be applied to the opening 732.

Referring to FIG. 8A, the second plate 80 includes a conductive substrate 800 and a slit region 80a which is provided in the conductive substrate 800 and in which a plurality of slits 801 are formed. As already described, the slit region 80a may be configured to have a size sufficient to cover a coil.

The slit region 80a may be a region in which a plurality of slits 801 are formed, and may be configured in a shape that is the same as or similar to that of each of the openings illustrated in FIGS. 7A to 7D.

Each of the slits 801 in the slit region may be filled with a non-metallic material, a non-magnetic material, or an insulating material. The filled non-metallic material, non-magnetic material, or insulating material may be configured to be filled in approximately the same thickness as the second plate 80.

Each of the slits 801 formed in the slit region may linearly extend in a third direction in an opening shape extending in the third direction, and may extend in a fourth direction which is perpendicular to the third direction. The third direction may be the lateral direction of the electronic device.

First strips 803 may be included between each two adjacent slits 801. Each first strip 803 may extend from a first position (e.g., a first portion) to a second position (e.g., a second portion) in the conductive substrate 800 and may linearly extend in the third direction. The first strips 803 may be arranged at regular intervals along the fourth direction which is perpendicular to the third direction. The first position may be the start portion where each first strip 803 electrically extends, and the start portion may be the first position. The second position may be a portion where each first strip 803 is terminated, and may be an electrically connected portion. Respective first strips 803 may extend parallel to each other.

Referring to FIG. 8B, the second plate 81 includes a conductive substrate 810 and a slit region 81a which is provided in the conductive substrate 810 and in which a plurality of slits 811 are formed. As described above, the slit region 81a may be configured to have a size sufficient to cover a coil.

The slit region 81a may be a region in which a plurality of slits 811 are formed, and may be configured in a shape that is the same as or similar to that of each of the metal removal regions illustrated in FIGS. 7A to 7D.

Each of the slits 811 in the slit region 81a may be filled with a non-metallic material, a non-magnetic material, or an insulating material. The filled non-metallic material, non-magnetic material, or insulating material may be configured to be approximately the same thickness as the conductive substrate 810.

Each of the slits 811 formed in the slit region 81a may linearly extend in the fourth direction in an opening shape extending in the fourth direction, and may extend in the third direction which is perpendicular to the fourth direction.

First strips 813 may be included between each two adjacent slits 811. Each of the first strips 813 may extend from a third position (e.g., a third portion) 810 to a fourth position (e.g., a fourth portion) in the conductive substrate and may linearly extend in the fourth direction. The first strips 813 may be arranged at regular intervals along the third direction which is perpendicular to the fourth direction. The third position may be the start portion where each first strip 813 electrically extends, and the start portion may be the third position. The fourth position may be a portion where each first strip 813 is terminated, and may be an electrically connected portion. Respective first strips 813 may extend parallel to each other.

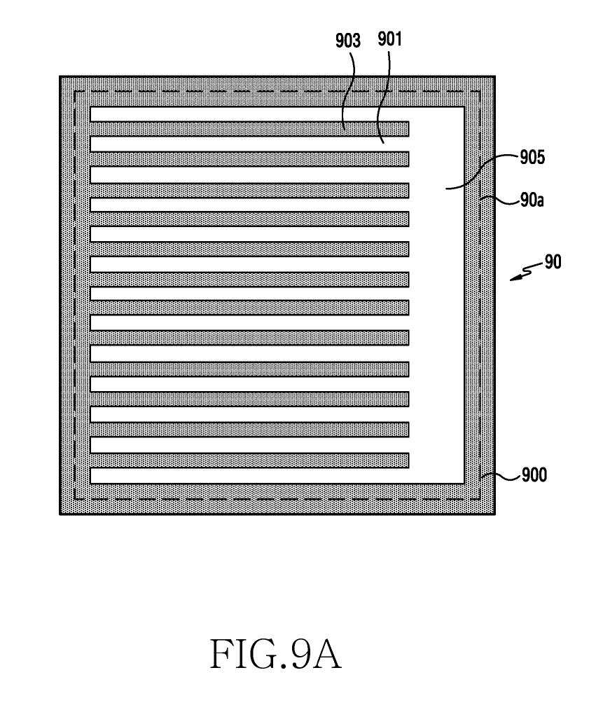

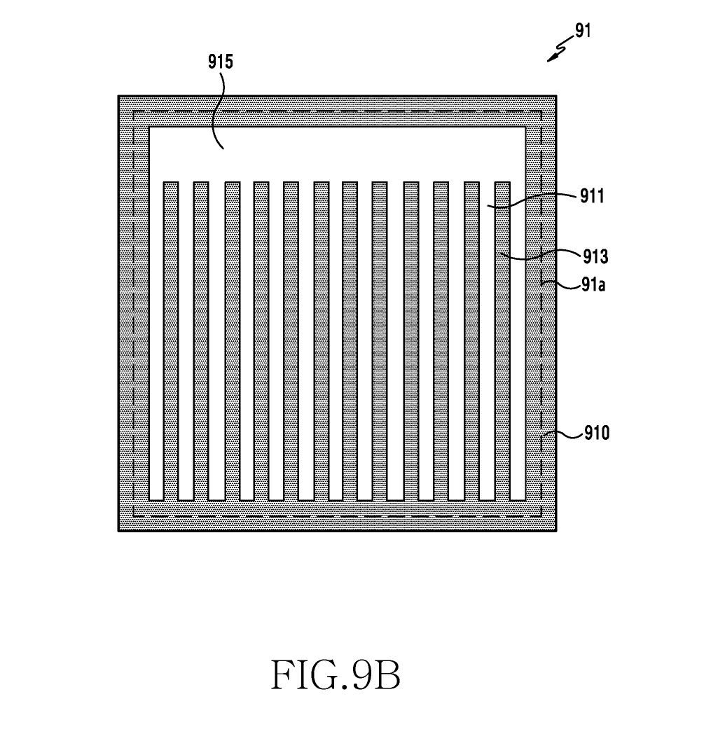

Referring to FIG. 9A, the second plate 90 includes a conductive substrate 900 and a slit region 90a which is provided in the conductive substrate 900 and in which a plurality of slits 901 are formed. For the convenience of explanation, the end on the left side (e.g., a first position) is referred to as one end (e.g., a first portion) and the end on the right side (e.g., a second position) is referred to as the other end (e.g., a second portion). The slit region 90a may be configured in a substantially square or rectangular shape when viewed from above.

In comparison with the slit region 80a illustrated in FIG. 8A, the slit region 90a illustrated in FIG. 9A may be formed by removing at least a portion of each first strip in the remaining region (e.g., a second position) of the slit region 90a. The removed portions in a side portion of the slit region 90a may be formed as an opening 905 and the respective slits 901 may spatially communicate with each other via the opening 905.

A first strip 903 may be interposed between each two adjacent slits 901 in the slit region 90a. First strips 903 may be formed linearly and may be provided at regular intervals in the slit region. One end of each of the first strips 903 may be integrally connected to the metal region 900, and the other end may have the same structure as a free end. The electronic device can be improved in terms of charging efficiency by the right end opening 905 formed in the slit region. In addition, the first position may be the start portion where each first strip 903 electrically extends, and the start portion may be the first position. The second position may be a portion which is spaced apart from the first strip 903, and may be an electrically non-connected portion. The right end opening 905 is not limited in the forming position, and the opening may be located at the left end.

Referring to FIG. 9B, the second plate 91 includes a conductive substrate 910 and a slit region 91a, which is provided in the conductive substrate 910 and in which a plurality of slits 911 are formed. For the convenience of explanation, the end on the upper side (e.g., a third position) is referred to as upper end (e.g., a third portion) and the end on the lower side (e.g., a fourth position) is referred to as the lower end (e.g., a fourth portion). The slit region 91a may be configured in a substantially square shape when viewed from above.

In comparison with the slit region 81a illustrated in FIG. 8B, the slit region 91a illustrated in FIG. 9B may be formed by removing at least a portion of each first strip 913 in the upper region (e.g., a third position) of the slit region 91a. The removed portions in the upper portion of the slit region 91a may be formed as an opening 915, and the respective slits 911 may spatially communicate with each other via the opening 915.

In addition, the third position may be the start portion where each first strip 913 electrically extends, and the start portion may be the third position. The fourth position may be a portion which is spaced apart from the first strip 913, and may be an electrically non-connected portion.

A first strip 913 may be interposed between each two adjacent slits 911 in the slit region 91a. First strips 913 may be formed linearly and may be provided at regular intervals in the slit region. The electronic device may be improved in terms of charging efficiency by the upper end opening 915 formed in the slit region 91a. The upper end opening 915 may be located in the upper end region. Without being limited thereto, however, the upper end opening 915 may be positioned in the lower end.

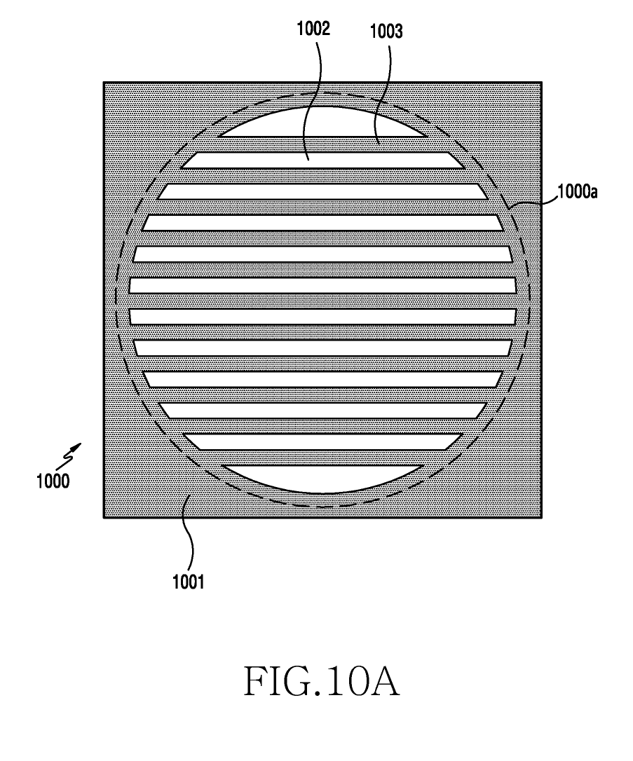

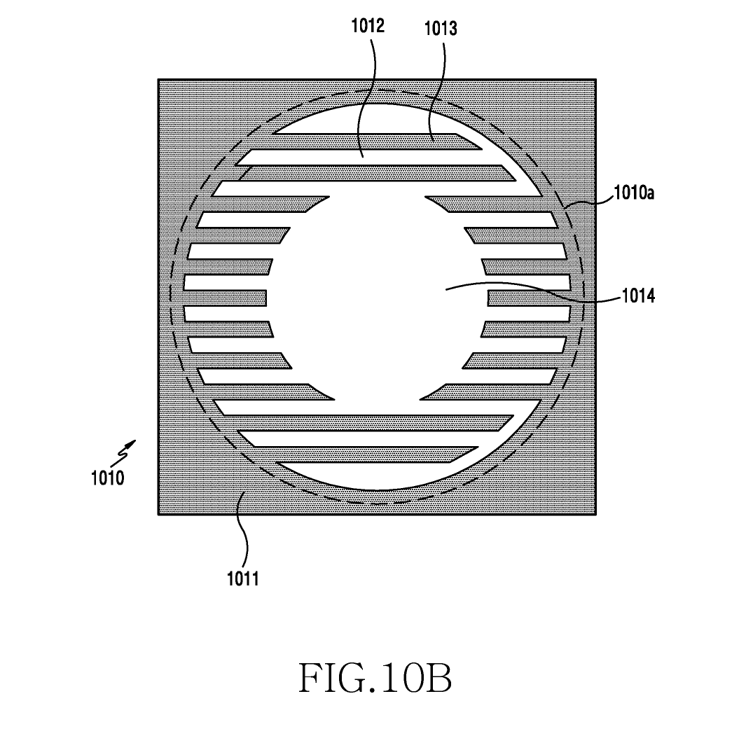

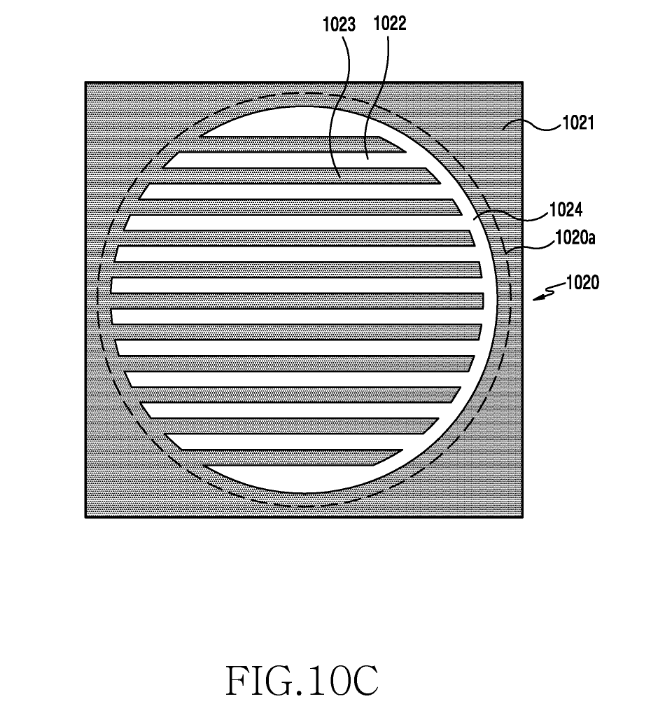

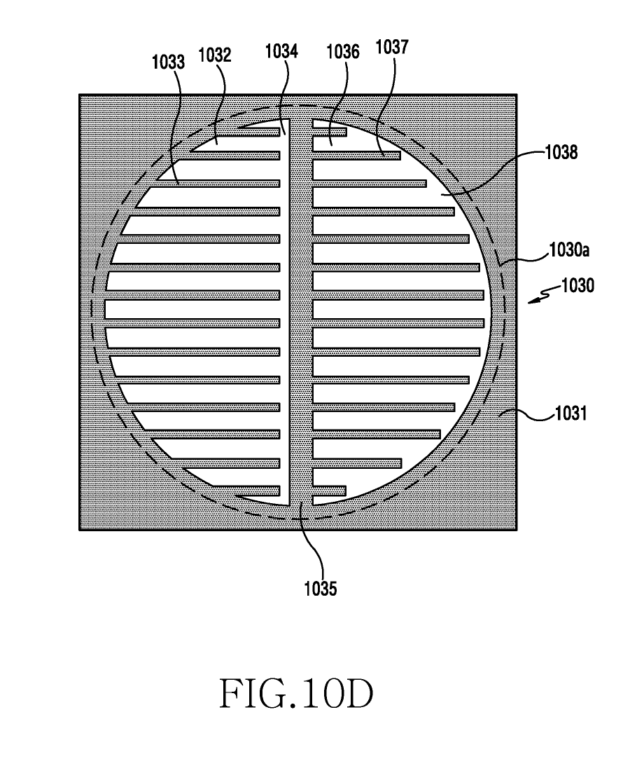

Referring to FIG. 10A, the second plate 1000 includes a conductive substrate 1001 and a slit region 1000a, which is provided in the conductive substrate 1001 and in which a plurality of slits 1002 are formed. As already described, the slit region 1000a may be configured to have a size sufficient to cover a coil.

The slit region 1000a is a region where a plurality of slits 1002 are formed, which may be formed in a circular shape when viewed from above, and may be configured to have the same size as the outer diameter (e.g., 40 mm) of the coil. Each of the slits 1002 in the slit region 1000a may be filled with a non-metallic material, a non-magnetic material, or an insulating material. The filled non-metallic material, non-magnetic material, or insulating material may be configured to be filled in approximately the same thickness as the second plate 1000.

Each of the slits 1002 formed in the slit region 1000a may linearly extend in a third direction in an opening shape extending in the third direction, and may extend in a fourth direction which is perpendicular to the third direction. The third direction may be the lateral direction of the electronic device.

A plurality of first strips 1003 may be included between each two adjacent slits 1002. Each of the first strips 1003 may extend in the conductive substrate 1001, and may linearly extend in the third direction. The first strips 1003 may be arranged at regular intervals along the fourth direction which is perpendicular to the third direction.

The first position may be the start portion where each first strip 1003 electrically extends, and the start portion may be the first position. The second position may be a portion where each first strip 1003 is terminated, and may be an electrically connected portion. The first strips 1003 may extend parallel to each other.

Referring to FIG. 10B, since the second plate 1010 is configured to be substantially the same as the second plate 1000 illustrated in FIG. 10A, except for the configuration in which a circular opening 1014 is formed in the center of the slit region 1010a, a redundant description of the other configurations will not be repeated. The second plate 1010 further includes a center opening 1014 having a predetermined diameter in the center of the slit region 1010a. The center opening 1014 may spatially communicate with at least a portion of each slit 1012 and may split at least a portion of each first strip 1013. The wireless charging efficiency of the electronic device may be improved by the center opening 1014 formed in the slit region 1010a.

Referring to FIG. 10C, since the second plate 1020 is configured to be substantially the same as the second plate 1000 illustrated in FIG. 10A, except for the configuration in which a side opening 1024 is formed in the vicinity of one side circumference portion of the slit region 1020a, a redundant description of the other configurations will not be repeated. The second plate 1020 may further include a side opening 1024 in the vicinity of one side circumference portion of the slit region 1020a. The side opening 1024 may spatially communicated with each slit 1022. The conductive substrate 1021 may include a plurality of strips 1023, in which one end of each strip 1023 may linearly extend on the conductive substrate 1021 and the other end may be configured as a free end. The electronic device can be improved in terms of wireless charging efficiency by the side opening 1024 formed in the slit region 1020a.

Referring to FIG. 10D, the second plate 1030 includes a conductive substrate 1031 and a slit region 1030a which is provided in the conductive substrate 1031, and, in which a plurality of slits 1032 and 1036 are formed. The slit region 1030a may be configured in a substantially circular shape when viewed from above, and may be segmented by a slit portion 1035. The slit region 1030a may include a first opening and a second opening. The first opening may have a substantially semicircular shape, and may include a first slit region (e.g., a left side). The second opening may have a substantially semicircular shape, and may include a second slit region (e.g., a right side). The first and second slit regions can be divided by the split metal portion 1035. The first opening may include a first half circumference, and the second opening may comprise a second half circumference that is opposite the first half circumference. The first half circumference may include at least a portion of the first portion, and the second half circumference may include at least a portion of the second portion.

The first slit region may include a plurality of first slits 1032 and a plurality of first strips 1033, each of which is disposed between each of two adjacent first slits 1032. The other end of each first strip 1033 may be cut to form a first opening 1034. The first slits 1032 may spatially communicate with each other via the first opening 1034. In addition, each first strip 1033 may be disposed in a free end type by the first opening 1034. The respective first strips 1033 may extend parallel to each other in the direction of the split portion 1035 in the first circumferential portion, may be electrically connected to the conductive substrate 1031 in the first circumferential portion, and may be electrically separated from the substrate 1031 in the split portion 1035.

The second slit region includes a plurality of second slits 1036 and a plurality of second strips 1037, each of which is disposed between each two adjacent second slits 1036. The other end of each second strip 1037 may be cut to form a second opening 1038. The second slits 1036 may spatially communicate with each other via the second opening 1038. In addition, each second strip 1037 may be disposed in a free end type by the second opening 1038. The electronic device may be improved in terms of charging efficiency by the first and second slit regions disposed in the slit region.

The respective second strips 1033 may extend parallel to each other toward the second circumferential portion 1035 from the split portion 1035, may be electrically connected to the conductive substrate 1031 in the split portion 1035, and may be electrically disconnected from the conductive substrate 1031 in the second circumferential portion.

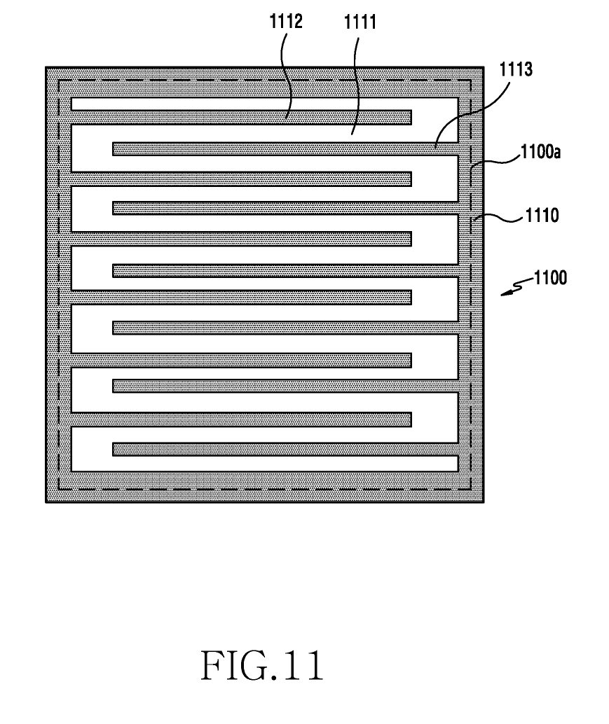

Referring to FIG. 11, the second plate 1100 includes a slit region 1100a having a plurality of slits 1111. For example, the slit region 1100a may have a square shape when viewed from above. The slit region 1100a may include a conductive substrate 1110, first and second strips 1112 and 1113, respectively, and a plurality of slits 1111.

The slit region 1100a includes one or more first strips 1112 each having one end integrally connected to the conductive substrate 1110 and the other end being formed as a free end. In addition, the slit region 1100a includes one or more second strips 1113, the other ends of which are integrally connected to the conductive substrate 1110 and one ends of which are formed as a free end. The second strips may be spaced apart from the first strips 1112 by the slits 1111. A slit 1111 may be disposed between each of two adjacent first and second strips 1112 and 1113.

Each first strips 1112 may extend from a first portion to a second portion of the periphery of the opening, may be electrically connected to the conductive substrate 1110 in the first portion, and may be electrically disconnected from the conductive substrate 1110 in the second portion. Each second strips 1113 may extend from the second portion to the first portion of the periphery of the opening, may be electrically connected to the conductive substrate 1110 in the second portion, and may be electrically disconnected from the conductive substrate 1110 in the first portion. The respective first strips 1112 may be formed to have the same length, or different lengths. The respective second strips 1113 may be formed to have the same length, or different lengths. In addition, each of the first strips 1112 may be formed to have a length that is the same or different from a length each of the second strips 1113.

The first and second strips 1112 and 1113, respectively, may be parallel to each other, may be spaced apart from each other, and may be arranged at regular intervals. In addition, the respective slits 1111 may be arranged parallel to each other, may be spaced apart from each other, may be arranged at regular intervals, and may be linearly formed to be spatially connected to each other.

According to an embodiment of the present disclosure, the respective slits 1111 may be spatially connected to each other, and may be configured to have about 10 to 12 turns.

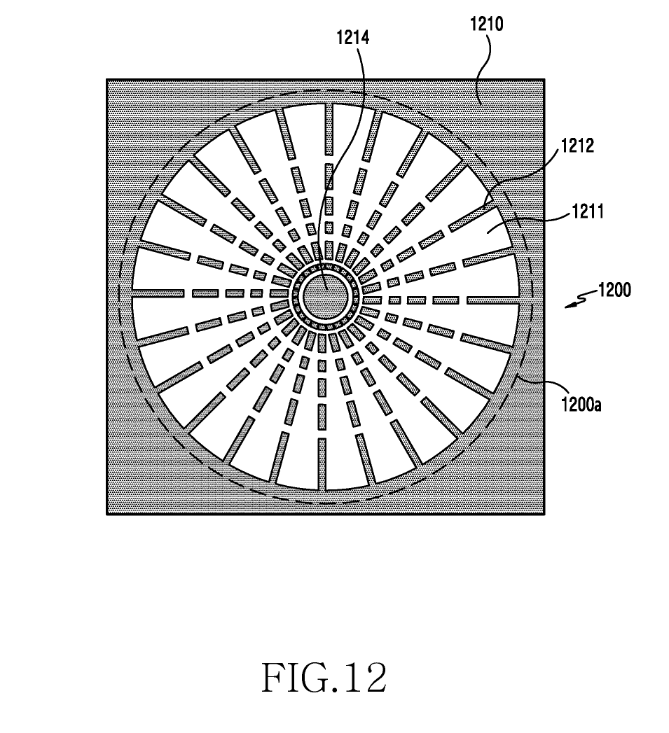

Referring to FIG. 12, the second plate 1200 includes a conductive substrate 1210 and a circular opening provided in the conductive substrate 1210. The opening includes a slit region 1200a in which a plurality of slits 1211 are disposed. The second plate 1200 may include a plurality of slits 1211 extending radially from the central conductive substrate 1214 which is disposed in the center of the second plate 1200. Between each two adjacent slits 1211, a conductive strip 1212 may be formed to extend from the conductive substrate 1210. Each conductive strip 1212 may be configured in a shape extending radially from the central conductive substrate 1214. The respective conductive strips 1212 may be formed on the central conductive substrate 1214 at an equal angle, and one or more conductive strips 1212 may be provided along the circumferential direction.

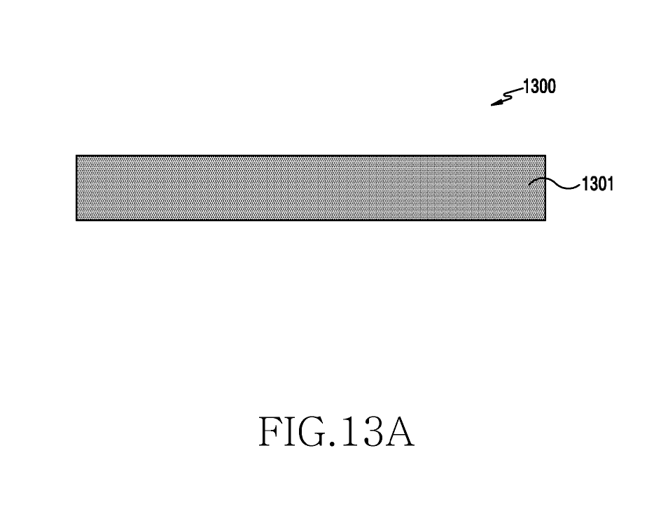

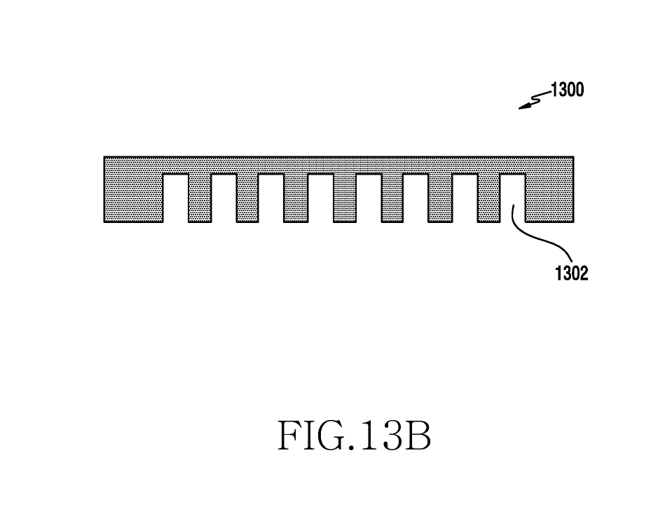

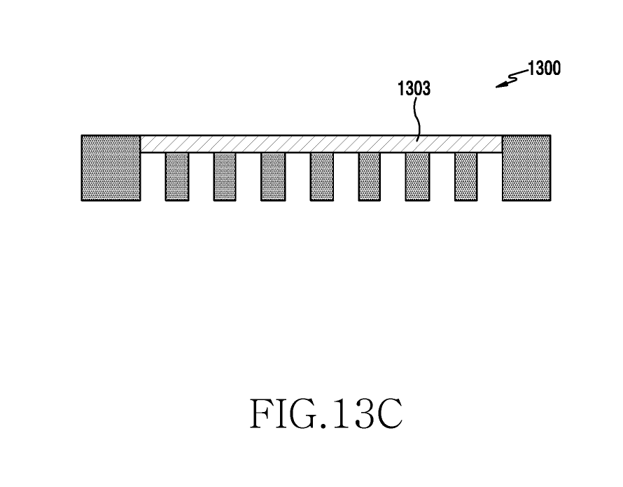

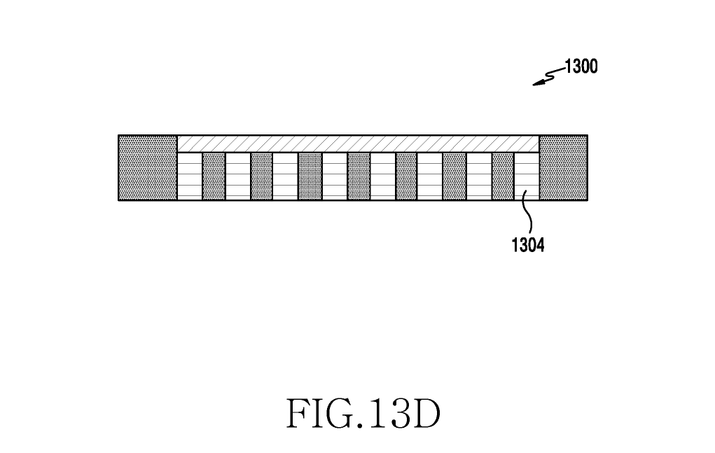

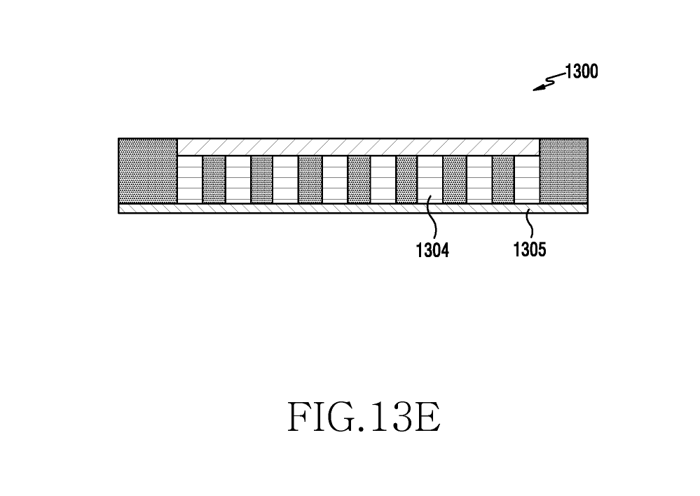

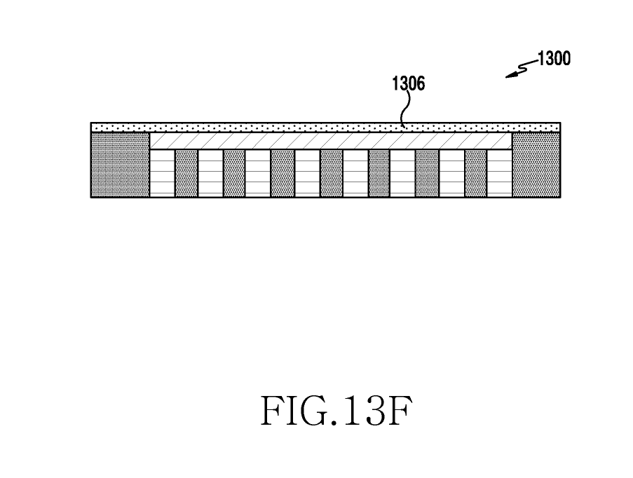

Referring to FIGS. 13A and 13B, a plurality of slits 1302 may be formed on a conductive substrate 1301 in a prepared second metal plate 1300 by a cutting process. Slits 1302 may be formed in the second plate 1300 at regular intervals. The conductive substrate 1301 may include aluminum.

Referring to FIG. 13C, in the second plate 1300 having the slits 1302 cut therein, the portions remaining after the cutting process for forming the slits may be subjected to oxidation treatment. The second plate may include a non-conductive layer, that is, an oxidized portion 1303 which covers the opening in a layer shape.

Referring to FIG. 13D, in the second plate 1300 including the oxidized portion 1303, the spaces in the slits may be filled with a non-conductive material, e.g., an insulating material. The slits may be completely filled with the insulating material. The second plate 1300 may include a plurality of first non-conductor portions 1304 which are spaced apart from each other at regular intervals. The insulating material may include aluminum oxide. The aluminum oxide may be configured to substantially cover the slits (e.g., openings).

Referring to FIG. 13E, the second plate 1300 may include a first non-conductive portion 1304 and a second non-conductive portion 1305 which were previously formed through a dual injection molding process. The first non-conductive portion 1304 and the second non-conductive portion 1305 may be made of different materials.

Referring to FIG. 13F, the second plate 1300 is coated with a paint layer 1306 by applying a paint on the second plate 1300 after the oxidation processing. The coating layer 1306 may be formed of an opaque material, and when the second plate 1300 is coated with the paint layer 1306, the slits may not be visible. The paint layer 1306 may be a coating layer that is exposed to the outside of the housing. The paint layer 1306 may be configured to at least partially cover the conductive substrate 1301 and the non-conductive substrate, that is, the non-conductive substrate in which the insulating material is filled in the openings and then cured.

When the second plate 1300 is manufactured according to the above-described process order, the slit region of the second plate 1300 may not be apparently visible, and may be coated with various colors.

As the second plate 1310 is manufactured through the above-described process, the conductive substrate of the manufactured second plate 1310 has an outer surface facing in the second direction, and the coating layer has a face facing the second direction. The outer surfaces of the conductive substrate and the respective coating layers may be formed to be flush with each other.

According to an embodiment of the present disclosure, an electronic device may include a housing including a first plate facing a first direction, a second plate facing a second direction opposite the first direction, and a side member surrounding a space between the first and second plates; a touch screen display exposed through the first plate; a processor located in the space; a wireless communication circuit located in the space and electrically connected to the processor; and an electrically conductive coil located in the space and electrically connected to the wireless communication circuit. The electrically conductive coil is wound around an axis extending in the second direction. The second plate may include a conductive substrate; an opening formed through or in a portion of the conductive substrate. A substantial portion of the coil is located between the opening and the first plate; a plurality of first conductive strips extending from a first position around the opening to a second location around the opening. The plurality of first conductive strips are electrically connected to the first portion and electrically disconnected from the second portion and extend from the opening; and an insulating material filled in at least a portion of the opening.

The plurality of first conductive strips may extend parallel to each other.

The opening may have a rectangular or rectangular shape including a first side and a second side parallel to the first side, the first side may form at least a portion of the first portion, and the second side may form at least a portion of the second portion.

The opening may have a circular shape including a first half circumference and a second half circumference that is opposite the first half circumference, the first half circumference may form at least a portion of the first portion, and the second half circumference may form at least a portion of the second portion.

The wireless communication circuit may be configured to transmit and/or receive a signal in a frequency range below 15 MHz.

The wireless communication circuit may be configured to support an NFC protocol.

The conductive substrate may include aluminum, and the insulating material may include aluminum oxide.

The aluminum oxide may form a non-conductive layer that covers a substantial portion of the opening.

The conductive substrate may include a surface facing the second direction, and the layer may have a surface facing the second direction, and the surfaces of the conductive substrate and the non-conductive substrate may be flush with each other.

The second plate may further include a coating layer that is exposed to an outside of the housing, and the coating layer may at least partially cover the conductive substrate and the non-conductive substrate.

The second plate may further include a plurality of second conductive strips extending from the opening, the plurality of second conductive strips may extend from the first portion around the opening to the second portion, and the second conductive strips may be electrically connected to the second portion and electrically disconnected from the first portion.

The opening may be formed in a circular shape, and may include a first opening having a substantially semi-circular shape, a second opening having a substantially semi-circular shape, a split portion interposed between the first and second openings, and a plurality of first and second conductive strips extending from the first and second openings, respectively, the plurality of first conductive strips may extend parallel to each other from a first circumferential portion of the first opening to the split portion, may be electrically connected to each other in the first circumferential portion, and may be electrically disconnected from each other in the split portion, and the plurality of second conductive strips may extend parallel to each other from the split portion to a circumferential portion of the second opening, may be electrically connected to each other in the split portion, and may be electrically disconnected in the second circumferential portion.

The opening may be formed in a substantially circular shape, the electronic device may further include a plurality of conductive strips extending from the opening, and the plurality of conductive strips may extend from a central portion of the opening in radial direction, and may be spaced apart from each other along a circumferential direction at regular intervals.

Each slit may be disposed between each two adjacent first conductive strips, and the plurality of slits may be formed to be spatially connected to or disconnected from each other.

The conductive coil may be configured as a coil that generates induction current during wireless charging of the electronic device.

The opening may be configured such that a plurality of conductive coils are capable of being disposed to face each other.

The first plate may be integrally manufactured with the housing, or may be separately manufactured to be detachable from the housing.

According to an embodiment of the present disclosure, an electronic device may include a rear cover; and a housing disposed to be overlap the rear cover and including a wireless charging coil body configured to generate induction current during wireless charging of the electronic device. The rear cover may include a conductive substrate; an opening formed in a portion of the conductive substrate; a plurality of conductive strips extending from the opening; a plurality of slits each disposed between each two adjacent conductive strips; and an insulating material filled in at least a portion of the opening.

The insulating material may be completely filled in each of the slits.

The rear cover may be manufactured integrally with the housing or may be detachably coupled to the housing.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. An electronic device, comprising:
a housing including a first plate facing a first direction, a second plate facing a second direction opposite the first direction, and a side member surrounding a space between the first and second plates;
a touch screen display exposed through the first plate;
a processor;
a wireless communication circuit; and
an electrically conductive coil that is wound around an axis extending in the second direction,
wherein the second plate includes:
a conductive substrate;
an opening formed through or in a portion of the conductive substrate,
wherein a portion of the coil is located between the opening and the first plate;
a plurality of first conductive strips extending from a first position around the opening to a second location around the opening,
wherein the plurality of first conductive strips are electrically connected to the first portion and electrically disconnected from a second portion and extend from the opening; and
an insulating material filled in at least a portion of the opening.

2. The electronic device of claim 1, wherein the plurality of first conductive strips extend parallel to each other.

3. The electronic device of claim 1, wherein the opening has a square or rectangular shape including a first side and a second side parallel to the first side,
wherein the first side forms at least a portion of the first portion, and
wherein the second side forms at least a portion of the second portion.

4. The electronic device of claim 1, wherein the opening has a circular shape including a first half circumference and a second half circumference that is opposite the first half circumference,
wherein the first half circumference forms at least a portion of the first portion, and
wherein the second half circumference forms at least a portion of the second portion.

5. The electronic device of claim 1, wherein the wireless communication circuit is configured to transceive a signal in a frequency range below 15 MHz.

6. The electronic device of claim 5, wherein the wireless communication circuit is configured to support a near field communication (NFC) protocol.

7. The electronic device of claim 1, wherein the conductive substrate includes aluminum, and
wherein the insulating material includes aluminum oxide.

8. The electronic device of claim 7, wherein the aluminum oxide forms a non-conductive layer that covers a portion of the opening.

9. The electronic device of claim 8, wherein the conductive substrate includes a surface facing the second direction,
wherein the non-conductive layer has a surface facing the second direction, and
wherein the surfaces of the conductive substrate and the non-conductive layer are flush with each other.

10. The electronic device of claim 8, wherein the second plate further includes a coating layer that is exposed to an outside of the housing, and
wherein the coating layer at least partially covers the conductive substrate and the non-conductive layer.

11. The electronic device of claim 1, wherein the second plate further includes a plurality of second conductive strips extending from the opening,
wherein the plurality of second conductive strips extend from the first portion around the opening to the second portion around the opening, and
wherein the second conductive strips are electrically connected to the second portion and electrically disconnected from the first portion.

12. The electronic device of claim 1, wherein the opening is formed in a circular shape, and includes a first opening having a substantially semi-circular shape, a second opening having a substantially semi-circular shape, a split portion interposed between the first and second openings, and a plurality of first and second conductive strips extending from the first and second openings, respectively,
wherein the plurality of first conductive strips extend parallel to each other from a first circumferential portion of the first opening to the split portion, are electrically connected to each other in the first circumferential portion, and are electrically disconnected from each other in the split portion, and
wherein the plurality of second conductive strips extend parallel to each other from the split portion to a circumferential portion of the second opening, electrically connected to each other in the split portion, and electrically disconnected in the second circumferential portion.

13. The electronic device of claim 1, wherein the opening is formed in a substantially circular shape,
wherein the electronic device further includes a plurality of conductive strips extending from the opening, and
wherein the plurality of conductive strips extend from a central portion of the opening in a radial direction, and are spaced apart from each other along a circumferential direction at regular intervals.

14. The electronic device of claim 1, wherein a plurality of slits is disposed between each of two adjacent first conductive strips, and the plurality of slits are formed to be to be one of spatially connected to and disconnected from each other.

15. The electronic device of claim 1, wherein the conductive coil generates induction current during wireless charging of the electronic device.

16. The electronic device of claim 1, wherein the opening is configured such that a plurality of conductive coils are capable of being disposed to face each other.

17. The electronic device of claim 1, wherein the first plate is one of integrally manufactured with the housing and separately manufactured to be detached from the housing.

18. An electronic device, comprising:
a rear cover; and
a housing disposed to overlap the rear cover and including a wireless charging coil body configured to generate induction current during wireless charging of the electronic device,
wherein the rear cover includes:
a conductive substrate;
an opening formed in a portion of the conductive substrate;
a plurality of conductive strips extending from the opening;
a plurality of slits each disposed between each two adjacent conductive strips; and
at least a portion of the opening filled with an insulating material.

19. The electronic device of claim 18, wherein the insulating material is completely filled in each of the plurality of slits.

20. The electronic device of claim 18, wherein the rear cover is manufactured integrally with one of the housing and detachably coupled to the housing.
